(19) United States
(12) Patent Application Publication
(10) Pub. No.: US 2017/0267591 A1
(43) Pub. Date: Sep. 21, 2017

(54) LAMINATED CERAMIC MOLDED ARTICLE HAVING RECESSES

(71) Applicant: CeramTec GmbH, Plochingen (DE)

(72) Inventors: Thomas BETZ, Weiden (DE); Harald KRESS, Langenzenn (DE)

(21) Appl. No.: 15/324,954

(22) PCT Filed: Jul. 10, 2015
(86) PCT No.: PCT/EP2015/065830

§ 371 Date: Jun. 6, 2017

(30) Foreign Application Priority Data
Jul. 10, 2014 (DE) 102014213480.3
Aug. 12, 2014 (DE) 102014215968.7

(51) Int. Cl. C04B 37/00

(52) U.S. Cl. CPC C04B 37/005; C04B 2237/066; C04B 2237/08; C04B 2237/341; C04B 2237/343; C04B 2237/348; C04B 2237/366; C04B 2237/368; C04B 2237/365; C04B 2237/62; F04B 19/006

(57) ABSTRACT

The invention relates to a ceramic molded article (1) that has recesses (2) and comprises at least two plates (joined parts) (3) made of a ceramic material, i.e. a lower base plate (9), an upper cover plate (8) and, optionally, one or more intermediate plates (7) which are stacked on top of each other and are joined to each other on the surfaces thereof to form the molded article (1); a joining material (paste) is placed between the plates (joined parts) (3).

The invention relates to a ceramic molded article having recesses, the method of its production, and its use.

Dry-pressed, strand-pressed, or film-molded ceramic molded articles can be milled or punched especially easily when still unsintered. By joining of several molded articles, for example using an applied ceramic paste, molded articles with complicated geometries such as undercut openings can be produced. There are serious limitations, however.

With larger and/or unevenly formed molded articles (of more than around 100 mm), because of inhomogeneous shrinkage during sintering, discrepancies in the desired final geometry may occur. The handling of molded articles that are thinner but with more extensive surface (for example, at 1-mm thickness, a lateral dimension of 200*300 mm) is difficult. Large molded parts with channel structures (usually milled dry-pressed parts) would have to be several millimeters thick in order to offer an adequate stability for processing. Thin ceramic films can indeed be handled, but the combination (stack formation) of many films with boreholes or windows of different widths is difficult, as the compaction is uneven at the openings during lamination.

The rapid, bubble-free combining of large-scale, absorbent molded articles that are coated with fluid and are still mechanically unstable is difficult.

Further, there is a high risk of crack formation during the sintering with complicated geometries.

To resolve this problem, a ceramic molded article having recesses was developed, which is characterized in that the molded article has at least two plates (joining parts) of ceramic material, namely a lower base plate, an upper cover plate, and optionally one or more intermediate plate(s), which are stacked on one another and are connected in a planar manner to the molded article and wherein a joining material (paste) is situated between the plates (joining parts).

Apart from that, a method for production of the molded articles is recommended, which is characterized in that,
a. flat ceramic green-body plates possibly with recesses are produced from a ceramic base material that is mixed with green-body-sintering agents, and these are subsequently sintered to create flat ceramic plates,
b. the ceramic plates may be laser treated or hardened in order to produce the required recesses and
c. a paste from the stirred ceramic base material mixed with sintering agents is applied to the sintered ceramic plates, and the ceramic plates coated in this way, also called joining parts, are piled in a stack and this stack is sintered.

Preferably the ceramic base material is aluminum nitride AlN and the sintering agent is Y₂O₃ or CaO.

So that an unnecessarily large structural space does not ensue, the joining parts have a thickness of less than 2 mm, preferably ≦1 mm.

In an embodiment according to the invention, metallizing elements are applied to the joining parts before or after sintering of the stack. These preferably are pressed on and subsequently are fused or hardened.

For creating cooling or heating spaces and channels, these are lasered as recesses into the ceramic plates in such a way that cooling or heating structures such as channels or meanders are formed in the joined molded articles. After the lasering, if wall structures remain in the ceramic plates, the cooling or heating medium can be guided to the points where special cooling or heating or temperature control is necessary.

So that the cooling or heating medium can be guided into the molded article, fastening elements or closing elements, which in one embodiment are fused and are connected to the recesses, are connected to the molded article.

The fastening elements advantageously are fastening pipes with a hose connector or pipe sections, which have a projecting flange, which in the region of the recesses is connected to the molded article, or which is fused between two ceramic plates.

A molded article according to the invention is characterized in that the molded article consists of at least two ceramic plates, a lower base plate, optionally one or more intermediate plate(s), and an upper cover plate, wherein in the base plate or cover plate boreholes are made, and in the base plate or the intermediate plates(s) channels and/or recesses are arranged, wherein the boreholes are connected to the channels and/or recesses.

In one embodiment, the molded article is a micropump that is characterized in that it consists of three ceramic plates, one lower base plate with an axis pin, on which a metallic or metallized impeller is arranged, an intermediate plate, which has the pump chamber and the feed lines, and an upper cover plate, that covers the pump chamber and the feed lines.

For producing geometrically complicated, exactly dimensioned molded articles, according to the invention sintered flat ceramic plates are initially lasered in order to provide the necessary recesses. Then a paste of stirred ceramic material is applied with screen print, roller (or other coating method). The coated joining parts are then combined in a stack and sintered again.

If the ceramic consists of AlN, which is usually mixed with a sintering agent such as Y₂O₃ in a concentration of 2-5%, by use of a joining material with a slightly increased or decreased concentration of Y₂O₃ in comparison with the base material, intensified diffusion of the Y₂O₃ or the formed Y AlO phases of joining material into the molded articles may be achieved, which leads to nearly complete freedom from defects in the joining zone and hermetically gas-tight components.

Since these pre-sintered joining parts are already very stable, the individual joining parts can therefore be made relatively thin, for example less than 1 mm thick.

The molded articles can be metallized on the inside and on the surface. Inner metallization can be especially suitable with high-melting metals such as platinum, molybdenum, or tungsten. Outer metallization can be carried out with the known methods/materials (W, Mo, Ag, Cu, etc.).

Openings with different diameters can be made in the individual levels of the molded article, for example by means of lasers (exact geometry), wherein the openings can be of equal size through the molded article, or are progressive, or are optionally alternating.

Channels or meanders (cooling or heating structures) can also be made in the joined molded articles, which can be used for temperature control.

The molded articles can also have recesses to save on weight, wherein ultimately only a fine stable ceramic framework is created.

Several molded articles joined in n levels can also be hermetically connected laterally like tiles to further molded articles.

Such layered molded articles may be used for example in vacuum chucks, heating plates, and coolers.

The example below is intended to describe the invention more closely, without limiting it.

### EXAMPLE

Three semicircular, film-injected and sintered plates—1 mm thick, radius 100 mm—made of AlN with Y₂O₃ as the sintering agent are lasered. Here different-size circles are cut out of each plate in such a way that after placement of the 3 plates over one another, different-width openings also lie centrally one over the other.

A paste of AlN and Y₂O₃ is produced by suspension of the solids in a suitable oil (screen print oil, organic paste). In the screen print method it is pressed onto the plates to be connected and the plates coated in this way are then placed/glued on one another.

This arrangement of three glued AlN plates is sintered at suitable temperatures in N₂.

With the molded articles according to the invention, molded parts can also be produced for cooling of power components, light sources, or temperature-sensitive components.

The expression “substantially” or “around” means, within the meaning of the invention, deviations from the exact value of ±10%, preferably ±5% and/or deviations in in the form of changes that are insignificant for the function.

The molded articles according to the invention thus have several plates, each of which consists of ceramic material, lying in a stack one on the other, and connected to the molded article in a planar manner. Preferably the molded article has metallizing elements on its surface, onto which the power components can be soldered. For temperature control, in the molded article there is a cooling or heating structure, that is, flow paths for a cooling or heating medium, which are acted upon by a cooling or heating medium, preferably a cooling or heating liquid, so that the cooling or heating structure can be used for temperature control. The cooling or heating medium is pumped or suctioned through the cooling or heating structure or can flow through it under the force of gravity. So that the cooling or heating medium can be guided into the molded article, in the base plate or the cover plate there are at least two openings that can be connected by fastening flanges. In one preferable embodiment, the cooling or heating channels are in the axial direction parallel to the surface faces of the base or cover plate.

Preferably the base plate of the molded article according to the invention has at least one elevation that is at the same height as the edge region of the base plate. These elevations thus have the full height of the base plate and serve first of all for guiding the cooling and heating medium, and secondly as a support surface for the cover plate or the ceramic plate positioned above it.

The ceramic material of the ceramic plates can be selected from one or more of the following groups: aluminum oxide, aluminum nitride, silicon nitride, silicon carbide, or a mixed ceramic of aluminum oxide zirconium oxide (ATZ or ZTA) or silicon oxide (aluminosilicate).

Further developments, advantages, and use options of the invention follow from the following description of the exemplary embodiments. All of the described and/or graphically depicted features by themselves or in any combination are the subject matter of the invention, independently of their summaries in the claims or their back-references. Also the contents of the claims are made a component of the description.

The ceramic molded articles according to the invention can be used as a temperature controllable vacuum chuck for the production of Si wafers.

In addition, the ceramic molded articles according to the invention are suited for use as setter plates, for example for metal injection molding.

Apart from that, the ceramic molded articles can be used as a (heatable/coolable) module for temperature control of energy storage devices such as batteries or accumulators.

The invention is explained below in more detail with reference to the figures of exemplary embodiments.

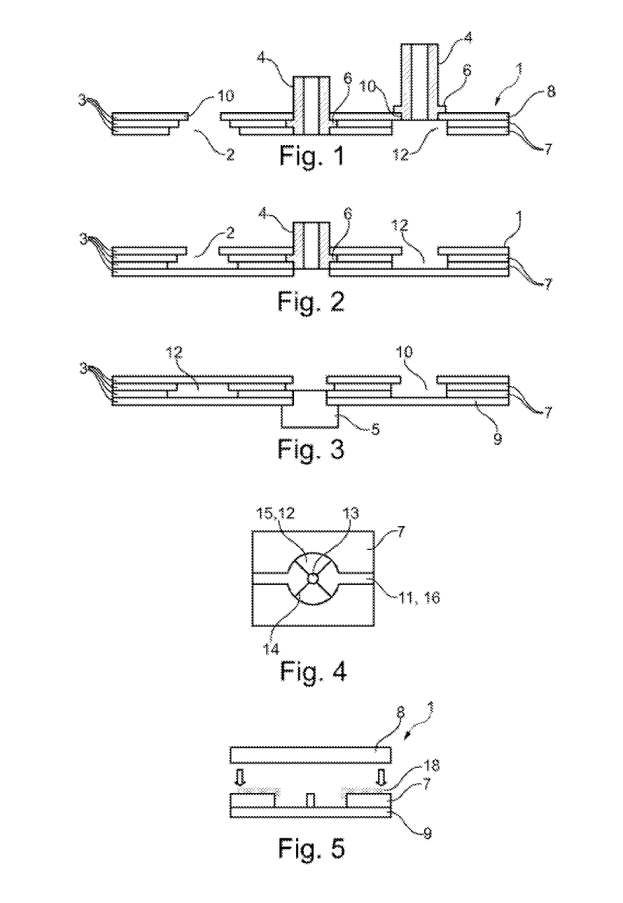

FIG. 1 shows a cutout from a ceramic molded article 1 according to the invention, which consists of a number of ceramic plates 3. Intermediate plates from a ceramic material are marked with the reference sign 7. A ceramic cover plate 8 is placed on the topmost intermediate plate 7 and fused. Boreholes 10 are made in the cover plate 8, through which a cooling medium can be guided into the molded article. Recesses 2 are lasered in the intermediate plates 3, which recesses form boreholes, channels, and depressions 12. For connection of the temperature-control media, fastening elements 4 are connected to the molded article 1. These fastening elements in the shown embodiment have a projecting flange 6 and a through hole 17, which are connected to the recesses 2 or depressions 12. (Not shown: the fastening elements can be configured in the form of hose nozzles or pipe sections.) The projecting flange 6 may be glued to the molded article 1, but may also be sintered between two ceramic plates 3.

FIG. 2 shows the same embodiment as FIG. 1, but only with a fastening element 4.

FIG. 3 shows the same embodiment as FIGS. 1 and 2, but also with a closing element 5 and a base plate 9.

FIGS. 4 and 5 show a molded article according to the invention, which in this embodiment depicts the exemplary embodiment of a micro-pump. The micro-pump consists of 3 ceramic plates 3, a lower base plate 9 having an axis pin 13 on which a metallic or metallized impeller is arranged (shown only schematically), an intermediate plate 7, which contains a pump chamber 15 as the depression 12, and feed lines 16 or channels 11 for the medium to be pumped. An upper cover plate 8 covers the pump chamber 15 and the feed lines 16. The reference sign 18 schematically shows a paste prior to sintering. The impeller 14 is not shown in FIG. 5.

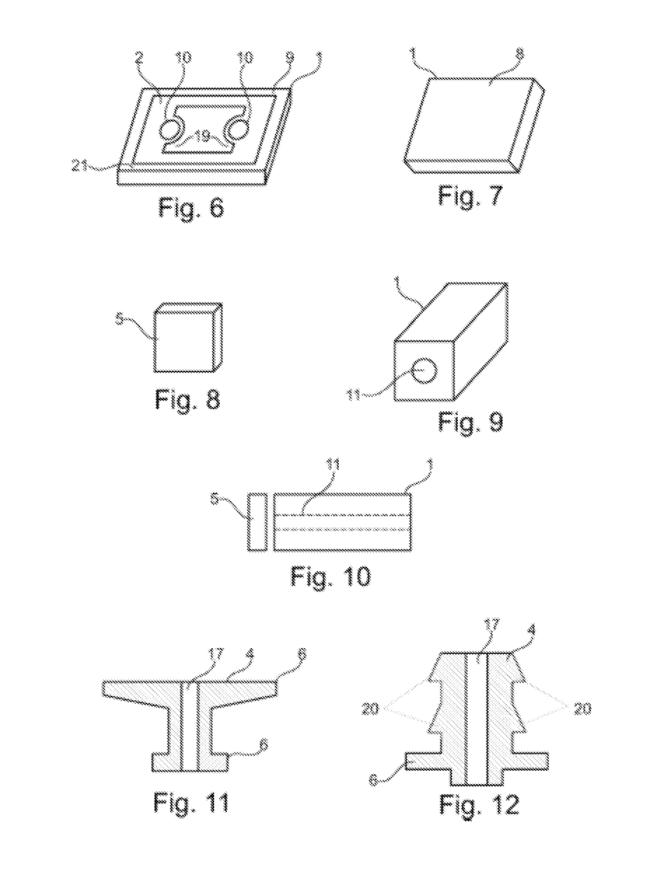

In FIGS. 6 and 7, a molded article 1 of two ceramic plates 3 is shown before sintering. Said molded article consists of a base plate 9 and a cover plate 8. A recess 2 is lasered into the base plate 9. In addition, two boreholes 10 run from the outside into the recess 2. In the recess, in the base plate 9 an elevation 19 is arranged, whose surface is at the same height as the edge region 21 of the base plate 9. This elevation 19 thus has the full height of the base plate 9 and serves first of all for guiding the cooling medium and secondly as a support surface for the cover plate 8. The elevation 19 is arranged between the boreholes 10 so that a desired flow path is formed.

In FIGS. 8, 9, and 10, a molded article 1 is shown with a channel 11, which is closed on the outside by a closing element 5. This closing element 5 can be glued on or else fused. FIGS. 11 and 12 show a fastening element 4 with radial projections 6 respectively. The fastening element 4 according to FIG. 12 consists of a flexible material, for example rubber, and with its hook 20 can close the channels.

1. A ceramic molded article with recesses, wherein the molded articles have at least two plates (joining parts) of ceramic material, namely a lower base plate, and upper cover plate, and optionally one or more intermediate plate(s), which are stacked on one another and are connected in a planar manner to the molded article, and wherein a joining material (paste) is situated between the plates (joining parts).

2. The ceramic molded article according to claim 1, wherein structures such as channels or meanders are molded as recesses in the plates.

3. The ceramic molded article according to claim 1, wherein the individual joining parts have a thickness of less than 2 mm, preferably 1 mm.

4. The ceramic molded article according to claim 1, wherein the base plate and the cover plate have boreholes and in the base plate or the intermediate plate(s) there are channels and/or depressions, wherein the boreholes are connected to the channels and the depressions.

5. The ceramic molded article according to claim 1, wherein that the molded article has a metallizing element on its surface.

6. The ceramic molded article according to claim 1, wherein the molded article has an inner metallizing element, in particular made of platinum, molybdenum, or tungsten.

7. The ceramic molded article according to claim 1, wherein in the individual levels of the molded article there are openings with different diameters, wherein the openings may be of equal size through the molded article or are progressive or are optionally alternating.

8. The ceramic molded article according to claim 1, wherein a cooling or heating structure, which comprises flow paths (cooling or heating channels) for the cooling or heating medium, is provided in the molded articles and the cooling or heating medium can be pumped through the cooling or heating structure, wherein there are at least two openings in the base plate or in the cover plate, which can be connected to attachment flanges.

9. The ceramic molded article according to claim 8, wherein the cooling and heating channels are in the axial direction parallel to the surface faces of the cover plate and the base plate.

10. The ceramic molded article according to claim 8, wherein the attachment elements or closure elements are connected to the molded article, preferably fused, that are connected to the recesses.

11. The ceramic molded article according to claim 10, wherein the fastening elements are fastening pipes, which have a projecting flange, which in the region of the recesses is connected the molded article, or which is fused between the two ceramic plates.

12. The ceramic molded article according to claim 1, wherein at least one elevation is situated in the base plate, which is at the same height as the edge region of the base plate, thus has the full height of the base plate.

13. The ceramic molded article according to claim 1, wherein the ceramic base material of the plates is selected from aluminum oxide, aluminum nitride, silicon nitride, and/or silicon carbide or from a mixed ceramic of aluminum oxide and zirconium oxide or silicon oxide and possibly contains a sintering agent.

14. The ceramic molded article according to claim 1, wherein the joining material is selected from aluminum oxide, aluminum nitride, silicon nitride, and/or silicon carbide or from a mixed ceramic of aluminum oxide and zirconium oxide or silicon oxide, and contains a sintering agent.

15. The ceramic molded article according to claim 1, wherein the joining material contains Y₂O₃ or CaO as the sintering agent.

16. The ceramic molded article according to claim 1, wherein the ceramic base material is aluminum nitride

17. The ceramic molded article according to claim 1, wherein the sintering agent of the joining material has a slightly increased or decreased concentration in comparison with the sintering agent of the ceramic base material.

18. The ceramic molded article according to claim 1, wherein the sintering agent of the ceramic base material is contained in a concentration of 2 to 5%, and the joining material has an increased concentration of sintering agent in comparison with the base material of around +1 to +5%.

19. The ceramic molded article according to claim 1, wherein the sintering agent is Y₂O₃ or CaO.

20. A method for producing a flat ceramic molded article according to claim 1, wherein
a. flat ceramic green-body plates possibly with recesses are produced from a ceramic base material that is mixed with green-body-sintering agents, and these are subsequently sintered to create flat ceramic plates,
b. the necessary recesses are provided in the ceramic plates,
c. a paste from the stirred ceramic base material mixed with sintering agents is applied to the sintered ceramic plates, and the ceramic plates coated in this way, also called joining parts, are piled in a stack and this stack is sintered.

21. The method according to claim 20, wherein the individual joining parts have a thickness of less than 2 mm, preferably 1 mm.

22. The method according to claim 20, wherein before or after sintering of the stack, metallizing elements are applied to the joining parts.

23. The method according to claim 20, wherein the recesses are made in the ceramic plates in such a way that in the joined molded article, structures such as channels or meanders are formed.

24. The method according to claim 20, wherein fastening elements or closing elements are connected to the molded article, preferable fused, that are connected to the recesses.

25. The method according to claim 24, wherein the fastening elements are fastening pipes, which have a projecting flange, which is connected to the molded article in the region of the recesses, or is fused between two ceramic plates.
